(19) United States
(12) Patent Application Publication
(10) Pub. No.: US 2013/0135360 A1
(43) Pub. Date: May 30, 2013

(54) DISPLAY DEVICE AND DRIVING METHOD THEREOF

(71) Applicants: Jun-Ho HWANG, Daegu (KR); Sung-In Kang, Asan-si (KR); Yong-Jin Shin, Asan-si (KR); Seung-Woon Shin, Asan-si (KR)

(72) Inventors: Jun-Ho HWANG, Daegu (KR); Sung-In Kang, Asan-si (KR); Yong-Jin Shin, Asan-si (KR); Seung-Woon Shin, Asan-si (KR)

(21) Appl. No.: 13/409,951

(22) Filed: Mar. 1, 2012

(30) Foreign Application Priority Data
Nov. 24, 2011 (KR) 10-2011-0123578

(51) Int. Cl. G09G 5/10; G09G 5/00

(52) U.S. Cl. 345/690; 345/212

(57) ABSTRACT

A display device includes first, second, and third gate lines. The display device further includes a first data line and a second data line neighboring the first data line. The display device further includes first, second, and third pixel electrodes connected to the first, second, and third gate lines, respectively, and further includes a fourth pixel electrode connected to the second gate line. The fourth pixel electrode is disposed between the first and third electrodes and neighbors each of the first, second, and third pixel electrodes. The first, second, and third pixel electrodes are connected to the first data line. The display device further comprises a gate driver for applying copies of a gate-on voltage to the gate lines, the gate-on voltage including a first voltage in a first horizontal period, a second voltage in a second horizontal period, and a third voltage in a third horizontal period.

### CROSS-REFERENCE TO RELATED APPLICATION

This application claims priority to and the benefit of Korean Patent Application No. 10-2011-0123578 filed in the Korean Intellectual Property Office on Nov. 24, 2011, the entire contents of which are incorporated herein by reference.

### BACKGROUND OF THE INVENTION

1. Field of the Invention

The present invention relates to a display device and a driving method thereof. More particularly, the present invention relates to a display device that may prevent undesirable horizontal lines from being conspicuously displayed in a mixed color pattern and relates to a method for driving the display device.

2. Description of Related Art

A display device is usually required for a computer monitor, a television, a mobile phone, etc., which are widely used. Examples of display devices include cathode ray tube displays, liquid crystal displays, plasma displays, etc.

Presently, the liquid crystal display is one of the most widely used flat panel displays. A typical liquid crystal display may include two display substrates in which a field generating electrode such as a pixel electrode, a common electrode, and other components are formed; the liquid crystal display may also include a liquid crystal layer that is inserted between the two display substrates. The liquid crystal display generates an electric field on the liquid crystal layer by applying a voltage to the field generating electrode, thereby determining the orientation of liquid crystal molecules in the liquid crystal layer for displaying an image. The liquid crystal display may also control the polarization of incident light for displaying the image.

The liquid crystal display may also include a switching element connected to each pixel electrode, and a plurality of signal lines such as gate lines, data lines, etc. The liquid crystal display may control voltages applied to the pixel electrodes by controlling the switching element.

The liquid crystal display displays a desired image by applying voltages to two electrodes to generate the electric field in the liquid crystal layer and by adjusting the magnitude of the electric field to adjust the transmittance of light that passes through the liquid crystal layer. In order to prevent degradation of the image, the polarity of a data voltage with respect to a common voltage may be inverted for each frame of the image, for each row of pixels, or for each pixel.

Recently, a high-speed driving method has been proposed for improving the motion picture display characteristic of the liquid crystal display. In the high-speed driving method, due to a fast frame rate, a large amount of power is typically consumed. For minimizing power consumption, a column inversion scheme may be implemented.

Further, to achieve the effect of dot inversion while minimizing power consumption with the column inversion scheme, thin film transistors disposed in a zigzagged pattern with respect to a data line may be implemented.

In order to provide sufficient charging time in the high-speed driving method, a pre-charging period may be implemented for extending the amount of time in which a gate-on voltage is applied to a pixel.

The pre-charging period may be undesirable if pixels representing the same color are disposed in a column direction. For instance, if pixels representing two colors are driven at a high luminance and if pixels representing a third color are driven at a low luminance, a portion of the pixels associated with the high luminance in the pre-charging period may be affected by neighboring pixels that are connected to the same data line and are associated with the low luminance. The affected pixels may not be sufficiently charged. Given that the affected pixels are not sufficient charged and may present an insufficient luminance, a portion of the pixels associated with the high luminance may appear to be excessively bright, and the affected pixels may appear to be excessively dark. As a result, an undesirable horizontal line may be conspicuously displayed.

For example, using the column inversion scheme, it is possible to drive the liquid crystal display in which red, green, and blue pixels are disposed alternately in columns, and thin film transistors are disposed to be zigzagged with respect to a data line. If a low data voltage needs to be applied to red pixels, and if high data voltage need to be applied to green and blue pixels, green and blue pixels continuously applied with high data voltage in the pre-charging period may indicate high luminance; however, green and blue pixels affected by red pixels applied with the low data voltage in the pre-charging period may present a relatively low luminance.

The Background section is only for enhancement of understanding of the background of the invention and therefore it may contain information that does not form the prior art already known in this country to a person of ordinary skill in the art.

### SUMMARY OF THE INVENTION

An embodiment of the present invention is related to a display device that enables a pixel to be relatively less affected by data voltages applied to pixels representing different colors from the instant pixel and to be relatively significantly affected by data voltages applied to pixels representing the same color as the instant pixel, thereby maximizing a charging rate of the corresponding pixel. An embodiment of the invention is related to method for driving the display device. Embodiments of the invention may prevent display device from displaying conspicuous undesirable horizontal lines in a mixed color pattern.

An embodiment of the present invention is related to a display device that includes a plurality of gate lines and a plurality of data lines. The display device may further include a plurality of pixel electrodes connected to the gate lines and the data lines. Among pixel electrodes that are positioned between two neighboring data lines among the data lines, neighboring pixel electrodes are connected to different data lines. The display device may further include a gate driver for applying copies of a gate-on voltage and copies of a gate-off voltage to the gate lines. The gate-on voltage has a first voltage in a first horizontal period, has a second voltage in a second horizontal period, and has a third voltage in a third horizontal period.

An embodiment of the invention is related to a display device that includes a first gate line, a second gate line, and a third gate line. The display device further includes a first data line and a second data line neighboring the first data line. The display device further includes a first pixel electrode electrically connected to the first gate line, a second pixel electrode electrically connected to the second gate line, a third pixel electrode electrically connected to the third gate line, and a fourth pixel electrode electrically connected to the second gate line. The first pixel electrode, the third pixel electrode, and the fourth pixel electrode are disposed between the first data line and the second data line. The fourth pixel electrode is disposed between the first electrode and the third electrode and neighbors each of the first pixel electrode, the second pixel electrode, and the third pixel electrode. The first pixel electrode, the second pixel electrode, and the third pixel electrode are electrically connected to the first data line. The display device further comprises a gate driver for applying copies of a gate-on voltage to the gate lines, the gate-on voltage including a first voltage in a first horizontal period, a second voltage in a second horizontal period that follows the first horizontal period, and a third voltage in a third horizontal period that follows the second horizontal period.

In one or more embodiments, the fourth pixel electrode is electrically connected to the second data line, and the polarities of the data voltages applied to the first and second data lines are different from (and opposite to) each other.

In one or more embodiments, the second voltage is lower than the first voltage, a difference between the second voltage and the first voltage is at least 5V and at most than 8V, and the first voltage is substantially equal to the third voltage.

In one or more embodiments, the first pixel electrode, the third pixel electrode, and the fourth pixel electrode are associated with a first color; the second pixel electrode is associated with a second color.

In one or more embodiments, when the first gate line receives a copy of the third voltage, the second gate line receives a copy of the second voltage, and the third gate line receives a copy of the first voltage (equal to the first voltage and higher than the second voltage).

In one or more embodiments, when the second gate line receives a copy of the third voltage, the third gate line receives a copy of the second voltage (lower than the third and first voltages).

An embodiment of the invention is related to a method for driving a display device. The display device may include a plurality of gate lines, a plurality of data lines, and a plurality of pixel electrodes connected to the gate lines and the data lines, the plurality of gate lines including a first gate line, a second gate line, and a third gate line, the plurality of data lines including a first data line and a second data line neighboring the first data line. The method may include applying a first copy of a first voltage to the first gate line in a first horizontal period, applying a first copy of a second voltage to the first gate line in a second horizontal period that follows the first horizontal period, applying a first copy of a third voltage to the first gate line in a third horizontal period that follows the second horizontal period, and applying a copy of a gate-off voltage to the first gate line.

The plurality of pixel electrodes may include a first pixel electrode electrically connected to the first gate line, a second pixel electrode electrically connected to the second gate line, a third pixel electrode electrically connected to the third gate line, and a fourth pixel electrode electrically connected to the second gate line. The first pixel electrode, the third pixel electrode, and the fourth pixel electrode are disposed between the first data line and the second data line. The fourth pixel electrode is disposed between the first electrode and the third electrode and neighbors each of the first pixel electrode, the second pixel electrode, and the third pixel electrode. The first pixel electrode, the second pixel electrode, and the third pixel electrode are electrically connected to the first data line. The fourth pixel electrode is electrically connected to the second data line. The polarities of the data voltages applied to the first and second data lines may be different from (and opposite to) each other.

In one or more embodiments, the second voltage is lower than the first voltage, a difference between the second voltage and the first voltage is at least 5V and at most 8V, and the first voltage is equal to the third voltage.

In one or more embodiments, the first pixel electrode, the third pixel electrode, and the fourth pixel electrode are associated with a first color; the second pixel electrode is associated with a second color.

The method may further include applying a second copy of the second voltage to the second gate line when applying the first copy of the third voltage to the first gate line.

The method may further include applying a second copy of the first voltage to the third gate line when applying the first copy of the third voltage to the first gate line.

The method may further include applying a second copy of the first voltage to the second gate line when applying the first copy of the second voltage to the first gate line.

The method may further include applying a second copy of the second voltage to the third gate line when applying a second copy of the third voltage to the second gate line.

Embodiments of the invention may enable a pixel to be relatively less affected by data voltages applied to pixels representing different colors from the instant pixel and to be relatively significantly affected by data voltages applied to pixels representing the same color as the instant pixel. Advantageously, a charging rate of the instant pixel may be maximized. In addition, embodiments of the invention may prevent display device from displaying conspicuous undesirable horizontal lines in a mixed color pattern.

### BRIEF DESCRIPTION OF THE DRAWINGS

FIG. 1 is a block diagram of a display device according to an embodiment of the present invention.

FIG. 2 is an equivalent circuit diagram of a single pixel in a display device according to an embodiment of the present invention.

FIG. 3 is a drawing schematically illustrating the spatial arrangement of pixel electrodes and signal lines of a liquid crystal panel assembly and a polarity of each pixel electrode according to an embodiment of the present invention.

FIG. 4 is a drawing schematically illustrating the spatial arrangement of pixel electrodes and signal lines of a liquid crystal panel assembly and a color of each pixel according to an embodiment of the present invention.

FIG. 5 is a drawing illustrating a gate signal applied to a gate line of a display device according to an embodiment of the present invention.

FIG. 6 and FIG. 7 are drawings illustrating control signals in a single pixel of a display device according to an embodiment of the present invention.

FIG. 8 is a drawing illustrating control signals for generating a gate signal of a display device according to an embodiment of the present invention.

### DETAILED DESCRIPTION OF THE EMBODIMENTS

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

A display device according to an embodiment of the present invention will be described below with reference to the accompanying drawings.

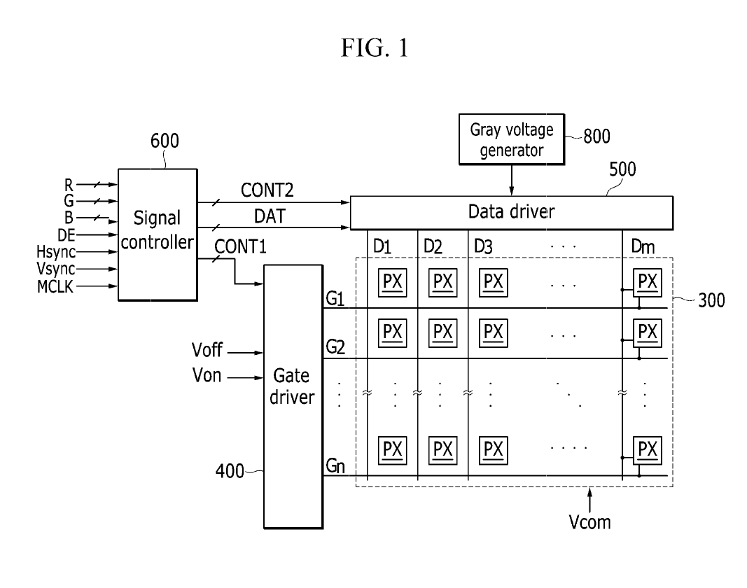

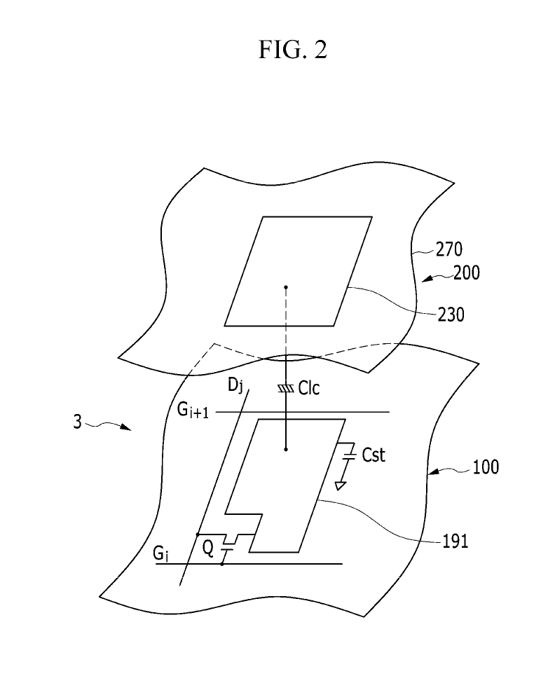

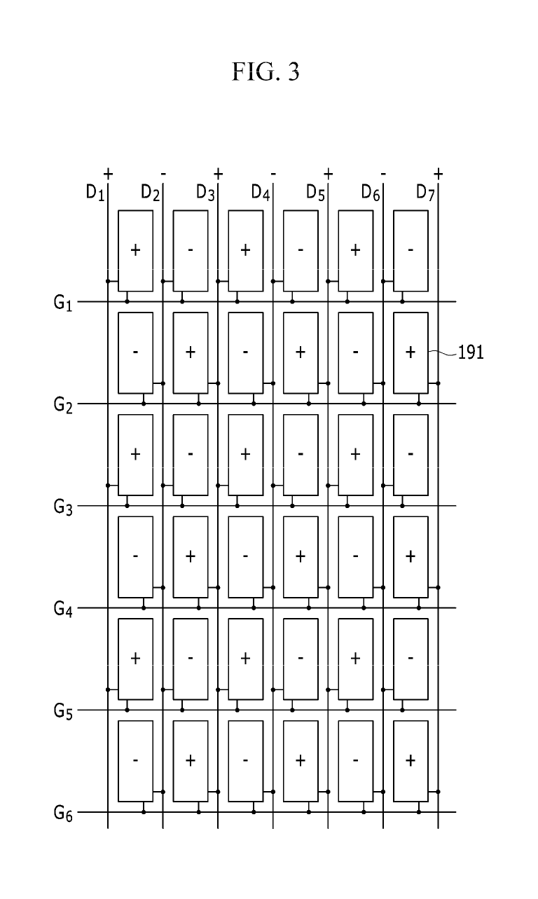

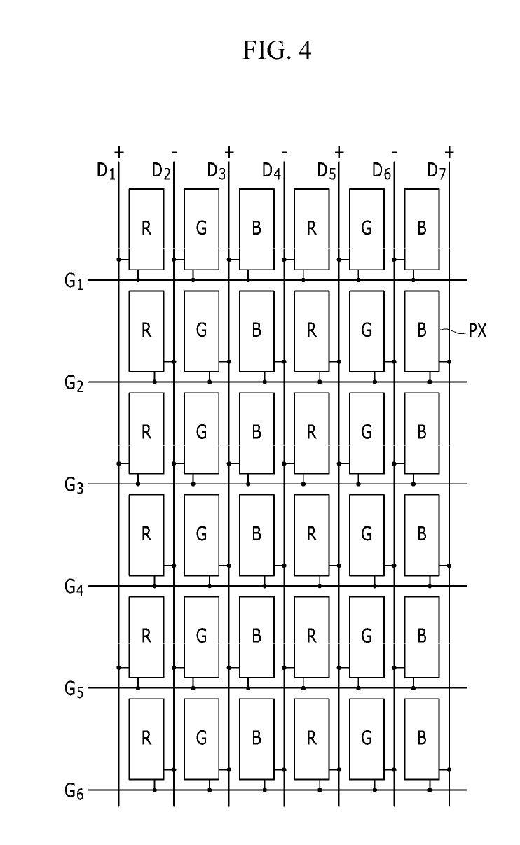

FIG. 1 is a block diagram of a display device according to an embodiment of the present invention, and FIG. 2 is an equivalent circuit diagram of a single pixel in a display device according to an embodiment of the present invention. FIG. 3 is a drawing schematically illustrating the spatial arrangement of pixel electrodes and signal lines of a liquid crystal panel assembly and a polarity of each pixel electrode according to an embodiment of the present invention, and FIG. 4 is a drawing schematically illustrating the spatial arrangement of pixel electrodes and signal lines of a liquid crystal panel assembly and a color of each pixel according to an embodiment of the present invention.

Referring to FIG. 1, the display device according to an embodiment of the present invention includes a liquid crystal panel assembly 300, a gate driver 400, a data driver 500, a gray voltage generator 800, and a signal controller 600.

The liquid crystal panel assembly 300 includes a plurality of signal lines G₁-Gₙ and D₁-Dₘ and a plurality of pixels PX that are connected thereto and are arranged in a matrix form. As illustrated in FIG. 2, the liquid crystal panel assembly 300 includes a lower panel 100 and an upper panel 200 that face each other, and a liquid crystal layer 3 disposed therebetween.

The signal lines G₁-Gₙ and D₁-Dₘ include a plurality of gate lines G₁-Gₘ configured to transmit gate signals (also referred to as a “scanning signals”) and a plurality of data lines D₁-Dₘ configured to transmit data voltages. The gate lines G₁-Gₙ extend in a row direction and are substantially parallel with each other, and the data lines D₁-Dₘ extend in a column direction and are substantially parallel with each other.

Each pixel PX, for example, a pixel PX that is connected to the i-th (i=1, 2, . . . , n) gate line Gᵢ and the j-th (j=1, 2, . . . , m) data line Dⱼ, includes a switching element Q that is connected to the gate line Gᵢ, the data line Dⱼ, a liquid crystal capacitor C_{lc}, and a storage capacitor Cₛₜ. The storage capacitor Cₛₜ may be omitted in one or more embodiments.

The switching element Q is a three-terminal element such as a thin film transistor that is provided in the lower panel 100 in one or more embodiments. A control terminal of the switching element Q is connected to the gate line Gᵢ, an input terminal thereof is connected to the data line Dⱼ, and an output terminal thereof is connected to the liquid crystal capacitor C_{lc} and the storage capacitor Cₛₜ.

The liquid crystal capacitor C_{lc} uses, as two terminals, a pixel electrode 191 of the lower panel 100 and a common electrode 270 of the upper panel 200. The liquid crystal layer 3 disposed between the pixel electrode 191 and the common electrode 270 functions as a dielectric material. The pixel electrode 191 is connected to the switching element Q. The common electrode 270 is formed on the whole surface of the upper panel 200 and is applied with common voltage Vcom. In one or more embodiments, the common electrode 270 may be provided at the lower panel 100 instead of the upper panel 200.

The storage capacitor Cₛₜ, which performs an auxiliary function of the liquid crystal capacitor C_{lc}, is configured by overlapping a separate signal line (not shown) provided on the lower panel 100 with the pixel electrode 191 and by providing an intervening insulator; a predetermined voltage such as common voltage Vcom is applied to the separate signal line. In one or more embodiments, the storage capacitor Cₛₜ may be configured by overlapping the pixel electrode 191 with a gate line Gᵢ₋₁ that is associated with an adjacent pixel and is disposed above the pixel electrode 191 and by using the insulator as a medium.

Referring to FIG. 3, pixel electrodes 191 are connected to gate lines G₁-G₆ and data lines D₁-D₇. Among the pixel electrodes 191 that are positioned between two neighboring data lines among the data lines D₁-D₇, neighboring pixel electrodes 191 are connected to different data lines.

For example, referring to the pixel electrodes 191 that are positioned between the first data line D₁ and the second data line D₂ to thereby constitute a single column, the first-row positioned pixel electrode 191 is connected to the first data line D₁, the second-row positioned pixel electrode 191 neighboring the first-row positioned pixel electrode 191 is connected to the second data line D₂, and the third-row positioned pixel electrode 191 is connected to the first data line D₁.

Referring to the data lines, among the pixel electrodes 191 connected to the second data line D₂, the pixel electrodes 191 positioned in the first, third, and fifth, that is, odd numbered rows are positioned on right of the second data line D₂, and the pixel electrodes 191 positioned in the second, fourth, and sixth, that is, even numbered rows are positioned on left of the second data line D₂. That is, the pixel electrodes 191 connected to the second data line D₂ are disposed in a zigzagged pattern with respect to the second data line D₂.

Although not illustrated, even thin film transistors connecting between the data lines D₁-D₇ and the pixel electrodes 191 are disposed to be zigzagged with respect to the data lines D₁-D₇, respectively.

In one or more embodiments, polarities of data voltages applied to the neighboring data lines are opposite to each other. For example, the polarity of data voltage applied to the odd numbered data lines D₁, D₃, D₅, and D₇ is a positive polarity (+), and the polarity of data voltage applied to even numbered data lines D₂, D₄, and D₆ is a negative polarity (−).

Here, since the pixel electrodes 191 are disposed to be zigzagged with respect to the data lines D₁-D₇, polarities of data voltage applied to respective adjacent pixel electrodes 191 along the column direction and along the row direction are different from each other. That is, even though the polarity of data voltage applied to the data lines D₁-D₇ is driven using the column inversion scheme of inverting the polarity of data voltages applied to the data lines D₁-D₇ by columns, a dot inversion effect associated with the pixel electrodes 191 may be obtained.

Referring to FIG. 4, to configure a color display, a desired color is enabled (to be recognized) as a spatial and/or temporal summation of primary colors by enabling each pixel PX to uniquely display one of primary colors (spatial division), or by enabling each pixel PX to alternately display primary colors over time (temporal division). Example of the primary colors may include three primary colors such as red, green, and blue. Referring to FIG. 4, pixels PX positioned in the first and fourth columns represent red pixels, pixels PX positioned in the second and fifth columns represent green pixels, and pixels PX positioned in the third and sixth columns represent blue pixels. In one or more embodiments, the pixels PX positioned in the same column are configured for displaying the same color, the pixels PX positioned in neighboring columns are configured for displaying different colors, and the pixels PX configured for displaying the same color are disposed to be repeated every three columns.

As shown in FIG. 2, the color of the pixels PX may be configured by providing a color filter 230 for presenting one of primary colors in an area of the upper panel 200 corresponding to the pixel electrode 191. In one or more embodiments, the color filter 230 may be disposed above or below the pixel electrode 191 of the lower panel 100.

At least one polarizer (not shown) is provided in the liquid crystal panel assembly 300.

Referring again to FIG. 1, the gray voltage generator 800 generates gray voltages (hereinafter, referred to as “reference gray voltages”), which may be a comprehensive set of gray voltages or a limited number of gray voltages associated with transmittance of the pixel PX. The reference gray voltages may have a positive value and a negative value with respect to the common voltage Vcom.

The gate driver 400 is connected to the gate lines G₁-Gₙ of the liquid crystal panel assembly 300 to thereby apply, to the gate lines G₁-Gₙ, gate signals including combinations of gate-on voltage Von and gate-off voltage Voff. The gate signals will be further described in the following description relating to the driving method.

The data driver 500 is connected to the data lines D₁-Dₘ of the liquid crystal panel assembly 300. The data driver 500 selects gray voltages received from the gray voltage generator 800 and applies the selected gray voltages to the data lines D₁-Dₘ as data voltages. However, when the gray voltage generator 800 provides a limited number of reference gray voltages instead of providing a comprehensive set of gray voltages, the data driver 500 selects desired data voltages by dividing the reference gray voltages.

The signal controller 600 controls the gate driver 400, the data driver 500, etc.

Each of the driving devices 400, 500, 600, and 800 may be directly or indirectly mounted on the liquid crystal panel assembly 300 in a form of at least one integrated circuit (IC) chip, may be mounted on a flexible printed circuit film (not shown) attached to the crystal panel assembly 300 in a form of a tape carrier package (TCP), or may be mounted on a separate printed circuit board (PCB) (not shown). In one or more embodiments, the driving devices 400, 500, 600, and 800 may be integrated on the liquid crystal panel assembly 300 together with the signal lines G₁-Gₙ and D₁-Dₘ and/or the thin film transistor switching elements Q. In one or more embodiments, the driving devices 400, 500, 600, and 800 may be integrated as a single chip. In one or more embodiments, at least one of the driving devices 400, 500, 600, and 800 or at least one circuit element constituting the driving devices may be positioned outside the single chip.

Hereinafter, a driving method of a display device according to an embodiment of the present invention will be described.

Referring to FIG. 1, the signal controller 600 receives input image signals R, G, and B, and input control signals from an external graphics controller (not shown). The input image signals R, G, and B contain luminance information of the respective pixels PX. Luminance has limited numbered, for example, 1024=2¹⁰, 256=2⁸, or 64=2⁶ grays. Examples of the input control signals include one or more of a vertical synchronization signal Vsync, a horizontal synchronizing signal Hsync, a main clock MCLK, and a data enable signal DE.

The signal controller 600 processes the input image signals R, G, and B to be suitable for an operating condition of the liquid crystal panel assembly 300 based on the input image signals R, G, and B and the input control signals to generate a gate control signal CONT1, a data control signal CONT2, and a processed image signal DAT. Subsequently, the signal controller 600 transmits the gate control signal CONT1 to the gate driver 400 and transmits the data control signal CONT2 and the processed image signal DAT to the data driver 500.

The gate control signal CONT1 includes a scanning start signal STV instructing a scanning start and a gate clock signal CPV controlling an output period of the gate-on voltage Von. The gate control signal CONT1 may further include an output enable signal OE limiting a duration of the gate-on voltage Von.

The data control signal CONT2 includes a horizontal synchronization start signal STH informing a transmission start of a digital image signal to the pixels PX of a row, a load signal LOAD applying analog data voltages to the data lines D₁-Dₘ, and a data clock signal HCLK. The data control signal CONT2 may further include an inversion signal RVS that inverts a polarity of a data voltage with respect to the common voltage Vcom (hereinafter, the “polarity of a data voltage with respect to the common voltage” is referred to as the “polarity of a data voltage”).

According to the data control signal CONT2 received from the signal controller 600, the data driver 500 receives the digital image signals DAT for the pixels PX of a single row and selects gray voltages corresponding to each digital image signal DAT, thereby converting the digital image signal DAT to analog data voltages and applying the converted analog data voltages to the data lines D₁-Dₘ.

According to the gate control signal CONT1 received from the signal controller 600, the gate driver 400 turns on the switching elements Q connected to the gate lines G₁-Gₙ by applying the gate-on voltage Von to the gate lines G₁-Gₙ. Subsequently, the data voltages applied to the data lines D₁-Dₘ are applied to corresponding pixels PX through the turned on switching elements Q.

A difference between a data voltage applied to a pixel PX and the common voltage Vcom is indicated as charging voltage, that is, a pixel voltage of the liquid crystal capacitor C_{lc}. Arrangement of liquid crystal molecules varies according to a magnitude of the pixel voltage; accordingly, the polarization of light passing the liquid crystal layer 3 changes. The change of the polarization appears as a change in the transmittance of light due to a polarizer attached to the liquid crystal panel assembly 300. As a result, each corresponding pixel PX displays luminance that is indicated by gray of the image signal DAT.

By repeating the above process per unit of a single horizontal period 1H (the length of which is the same as the length of a single period of the horizontal synchronizing signal Hsync and is the same as the length of the data enable signal DE), the gate-on voltage Von is sequentially applied to all of the gate lines G₁-Gₙ, and the data voltage is applied to all of the pixels PX to thereby display an image of a single frame.

When a single frame ends, a subsequent frame starts. A state of the inversion signal RVS applied to the data driver 500 is controlled so that the polarity of the data voltage applied to each pixel PX may be opposite to the corresponding polarity in the previous frame. The state of the inversion signal RVS is also controlled so that polarities of data voltages applied to neighboring data lines may be opposite to each other even within the single frame.

Hereinafter, gate signals applied to gate lines will be further described.

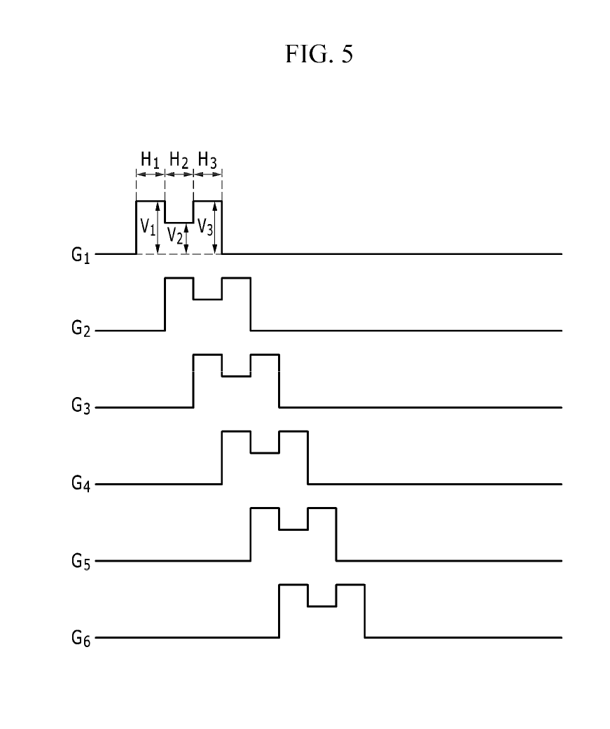

FIG. 5 is a drawing illustrating gate signals applied to gate lines of a display device according to an embodiment of the present invention.

The gate signals are configured such that a gate-on voltage Von and a gate-off voltage Voff may be alternately applied to each of the gate lines G₁-G₆, also illustrated in FIG. 3. In one or more embodiments, the gate-on voltage Von is applied for three horizontal periods 3H. The three horizontal periods 3H include the first horizontal period H₁, the second horizontal period H₂, and the third horizontal period H₃. Copies of the gate-on voltage Von are sequentially applied to the gate lines G₁-G₆ with an offset of 1H. For example, given that a first pixel electrode is electrically connected to the gate line G₁ and the data line D₂, a second pixel electrode is electrically connected to the gate line G₂ and the data line D₂, and a third pixel electrode is connected to the gate line G₃ and the data line D₂, 1H after the first pixel electrode has received a first copy of the gate-on voltage Von, the second pixel electrode receives a second copy of the gate-on voltage Von, and 2H after the first pixel electrode has received the first copy of the gate-on voltage Von, the third pixel electrode receives a third copy of the gate-on voltage Von.

Since the gate-on voltage Von is applied for three horizontal periods 3H, a charging time for each pixel PX becomes longer than when the gate-on voltage Von is applied for one single horizontal period 1H, and a charging rate also increases. In one or more embodiments, the third horizontal period H₃ corresponds to a point in time when a corresponding gate line is turned on, and corresponding data voltage is applied to the pixel electrode 191 connected to the corresponding gate line. The first horizontal period H₁ and the second horizontal period H₂ refer to two horizontal periods 2H ahead of the third horizontal period H₃, and one or more of data voltages corresponding to two previous pixel electrodes 191 connected to the same data line are applied to the instant pixel electrode 191 connected to the corresponding gate line. That is, using a pre-charging period, a charging rate increases by pre-charging using one or more of data voltages that are applied to two previous pixel electrodes 191 connected to the same data line.

The gate-on voltage Von has the first voltage V₁ in the first horizontal period H₁, has the second voltage V₂ in the second horizontal period H₂, and has the third voltage V₃ in the third horizontal period H₃. In one or more embodiments, the second voltage V₂ may be lower than the first voltage V₁. In one or more embodiments, the first voltage V₁ may be substantially equal to the third voltage V₃. Therefore, the second voltage V₂ may be lower than the third voltage V₃. For example, each of the first voltage V₁ and the third voltage V₃ may be 28V, and the second voltage V₂ may be 23V. In one or more embodiments, the difference between the first voltage V₁ and the second voltage V₂ may be set to be greater than or equal to 5V and less than or equal to 8V. Accordingly, the difference between the second voltage V₂ and the third voltage V₃ may also be set to be at least 5V and at most 8V.

By setting the first voltage V₁ and the third voltage V₃ to be substantially equal to each other, a corresponding pixel PX is further affected by data voltage applied to the previous pixel electrode 191 of the last pixel electrode 191 that is connected to the same data line. For example, when the first pixel electrode receives V₃, the third pixel electrode receives V₁, which is equal to V₃; therefore, the third pixel electrode may receive the same data voltage received by the first pixel electrode. By setting the second voltage V₂ to be lower than the first voltage V₁, the corresponding pixel PX is less affected by data voltage applied to the previous pixel electrode 191 that is connected to the same data line. For example, when the second pixel electrode receives V₃, the third pixel electrode receives V₂, which is lower than V₃; therefore, the third pixel electrode may or may not receive the same data voltage received by the second pixel electrode.

As shown in FIG. 4, the pixels PX disposed in the same column represent the same color and are alternately connected to two adjacent data lines. Given the V₁-V₂-V₃ gate-on voltage configuration and the 1H offset gate signal configuration, the data voltage association effect of pixels PX associated with the same color greater than the data voltage association effect of pixels PX associated with different colors. For example, the previously mentioned first pixel electrode may be associated with a green pixel, the second pixel electrode may be associated with a red pixel, and the third pixel electrode may be associated with a green pixel. The data voltage applied to the first pixel electrode (associated with a green pixel) may affect the third pixel electrode (associated with a green pixel) substantially more than the data voltage applied to the second pixel electrode (associated with a red pixel) affects the third pixel electrode (associated with a green pixel).

Hereinafter, a gate voltage and a data voltage in a pixel (given that pixels are disposed as shown in FIG. 4) will be discussed.

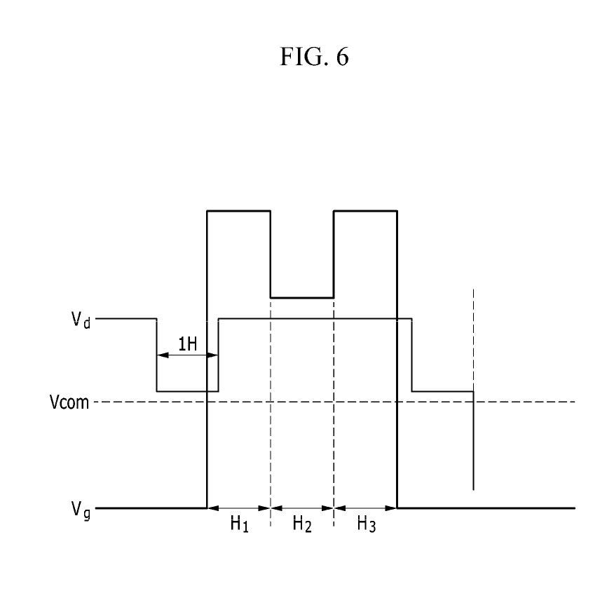

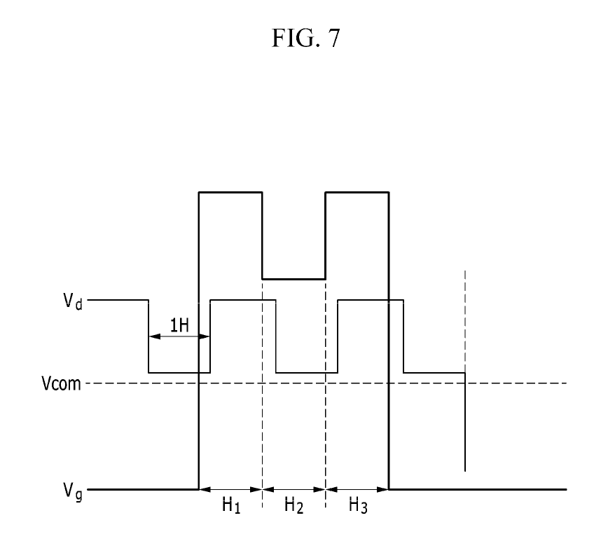

FIG. 6 and FIG. 7 are drawings illustrating control signals in a single pixel of a display device according to an embodiment of the present invention.

A case where all of the red pixels PX positioned between the first data line D₁ and the second data line D₂ present low luminance, all of the green pixels PX positioned between the second data line D₂ and the third data line D₃ present high luminance, and all of the blue pixels PX positioned between the third data line D₃ and the fourth data line D₄ present high luminance will be described as an example.

In the following discussion with reference to FIGS. 4 and 6, the blue pixel PX that is connected to the first gate line G₁ and the third data line D₃ is referred to as the first pixel, the green pixel PX that is connected to the second gate line G₂ and the third data line D₃ is referred to as the second pixel, and the blue pixel PX that is connected to the third gate line G₃ and the third data line D₃ is referred to as the third pixel. Referring to FIG. 6, the third pixel (a blue pixel) will be discussed as an example.

In the first horizontal period H₁, the third pixel is pre-charged using data voltage Vd applied to the first pixel. In one or more embodiments, the first pixel presents high luminance, and thus the associated data voltage helps increase a charging rate of the third pixel.

In the second horizontal period H₂, the third pixel is pre-charged using data voltage Vd applied to the second pixel. In one or more embodiments, the second pixel also presents high luminance, and thus the associated data voltage helps increase the charging rate of the third pixel.

Gate voltage Vg applied to the third gate line G₃ in the second horizontal period H₂ (e.g., V₂ illustrated in FIG. 5) is lower than gate voltage Vg in the first horizontal period H₁ (e.g., V₁ illustrated in FIG. 5). Accordingly, the effect on the third pixel (a green pixel) by the data voltage Vd applied to the second pixel (a green pixel) is less significant than the effect on the third pixel (a green pixel) by the data voltage Vd applied to the first pixel (a blue pixel).

In the third horizontal period H₃, the data voltage Vd is applied to the third pixel. Due to the pre-charged voltage, to the third pixel may sufficiently present luminance that the third pixel is configured to present.

In the following discussion with reference to FIGS. 4 and 7, the green pixel PX that is connected to the first gate line G₁ and the second data line D₂ is referred to as the first pixel, the red pixel PX that is connected to the second gate line G₂ and the second data line D₂ is referred to as the second pixel, and the green pixel PX that is connected to the third gate line G₃ and the second data line D₂ is referred to as the third pixel. Referring to FIG. 7, in the first horizontal period H₁, the third is pre-charged using data voltage Vd applied to the first pixel (a green pixel). In one or more embodiments, the first pixel (a blue pixel) presents high luminance, and thus the associated data voltage helps increase a charging rate of the third pixel.

In the second horizontal period H₂, the third pixel is pre-charged using data voltage Vd applied to the second pixel (a red pixel). In one or more embodiments, the second pixel (a red pixel) presents low luminance, and thus the associated data voltage does not help increase the charging rate of the third pixel.

Gate voltage Vg applied to the third gate line G₃ in the second horizontal period H₂ (e.g., V₂ illustrated in FIG. 5) is lower than gate voltage Vg in the first horizontal period H₁ (e.g., V₁ illustrated in FIG. 5). Accordingly, the effect on the third pixel (a green pixel) by the data voltage Vd applied to the second pixel (a red pixel) is less significant than the effect on the third pixel (a green pixel) by the data voltage Vd applied to the first pixel (a green pixel).

If the gate voltage Vg applied to the third gate line G₃ in the second horizontal period H₂ were equal to the gate voltage Vg in the first horizontal period H₁, the pre-charged voltage in the third in the first horizontal period H₁ might decrease due to the effect by the data voltage associated with the second pixel (a red pixel) that presents low luminance. As a result, actual luminance of the third pixel might be undesirably lower than actual luminance of the blue pixel PX connected to the third gate line G₃ and the third data line D₃.

According to an embodiment of the present invention, by setting the gate voltage Vg in the second horizontal period H₂ to be lower than the gate voltage Vg in the first horizontal period H₁, it is possible to decrease the effect by the data voltage for the second pixel, which is associated with a luminance level undesirable for the third pixel.

Advantageouly, embodiments of the invention may pre-charge the third pixel by utilizing the data voltage Vd applied to the first pixel (which is connected to the same data line as the third pixel); embodiments of the invention may also minimize the effect by data voltage Vd applied to the second pixel (which is also connected to the same data line as the third pixel).

Accordingly, when pixels corresponding to two predetermined colors among red, green, and blue are driven at high luminance and the remaining pixels are driven at low luminance, embodiments of the invention may increase a charging rate of a pixel since the pixel is relatively less affected by data voltages Vd applied to the pixels representing different colors from the pixel and is relatively significantly affected by data voltages Vd applied to the pixels representing the same color as the pixel. In addition, embodiments of the invention may uniformly maintain desirable luminance of neighboring pixels; advantageously, conspicuous undesirable horizontal lines may be prevented.

In the third horizontal period H₃, the data voltage Vd is applied to the third pixel. Due to the pre-charged voltage, to the third pixel may sufficiently present luminance that the third pixel is configured to present.

Hereinafter, a method of generating a gate signal applied to a gate line of a display device according to an embodiment of the present invention will be described.

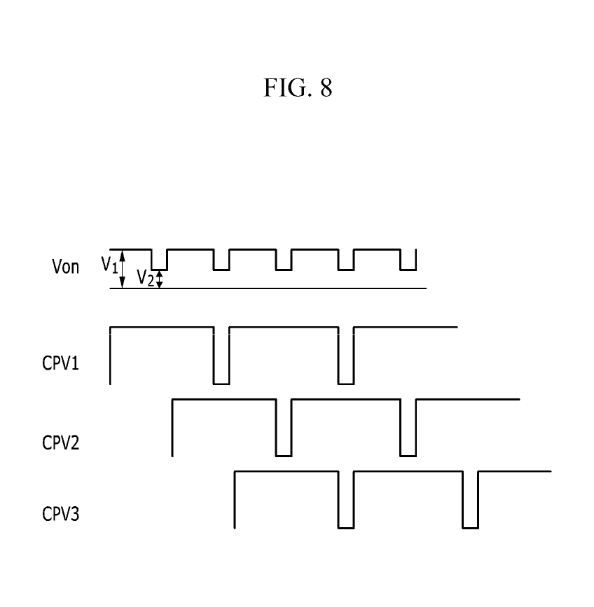

FIG. 8 is a drawing illustrating control signals for generating a gate signal of a display device according to an embodiment of the present invention.

Gate-on voltage Von is configured in a form in which the first voltage V₁ and the second voltage V₂ are alternated and repeated. A gate clock signal CPV selects a portion of period of the gate-on voltage Von and thereby controls an output period of the gate voltage. In one or more embodiments, the gate clock signal CPV may include the first gate clock signal CPV1, the second gate clock signal CPV2, and the third gate clock signal CPV3. That the number of gate clock signals CPV is three is only an example and thus, the number of gate clock signals CPV may be less than or greater than three.

In one or more embodiments, a first gate signal is selected by the first gate clock signal CPV1. Accordingly, a gate-off voltage Voff appears after a gate-on voltage Von that includes the first voltage V₁, the second voltage V₂, and the first voltage V₁, which are sequentially connected. The second occurrence of V₁ may correspond to the third voltage V₃ discussed with reference to FIG. 5. The second gate clock signal CPV2 and the third gate clock signal CPV3 also may be applied to generate gate voltages in the same form, and the generated gate voltages may be sequentially applied to different gate lines.

Even though the display device according to an embodiment of the present invention is described above as a liquid crystal display for example, embodiments of the present invention may be applicable to various types of display devices.

While this invention has been described in connection with what is presently considered to be practical embodiments, it is to be understood that the invention is not limited to the disclosed embodiments, but is intended to cover various modifications and equivalent arrangements within the spirit and scope of the appended claims.

<Description of symbols>

| | |
|---|---|
| 3: Liquid crystal layer | 100: Lower panel |
| 191: Pixel electrode | 200: Upper panel |
| 230: Color filter | 270: Common electrode |
| 300: Liquid crystal panel assembly | 400: Gate driver |
| 500: Data driver | 600: Signal controller |
| 800: Gray voltage generator | G₁-Gₙ: Gate lines |
| D₁-Dₘ: Data lines | PX: Pixel |

What is claimed is:

1. A display device comprising:
a plurality of gate lines including a first gate line, a second gate line, and a third gate line;
a plurality of data lines including a first data line and a second data line neighboring the first data line;
a plurality of pixel electrodes including a first pixel electrode electrically connected to the first gate line, a second pixel electrode electrically connected to the second gate line, a third pixel electrode electrically connected to the third gate line, and a fourth pixel electrode electrically connected to the second gate line, wherein
the first pixel electrode, the third pixel electrode, and the fourth pixel electrode are disposed between the first data line and the second data line,
the fourth pixel electrode is disposed between the first electrode and the third electrode and neighbors each of the first pixel electrode, the second pixel electrode, and the third pixel electrode, and
the first pixel electrode, the second pixel electrode, and the third pixel electrode are electrically connected to the first data line;
a gate driver for applying copies of a gate-on voltage to the plurality of gate lines,
the gate-on voltage including a first voltage in a first horizontal period, a second voltage in a second horizontal period, and a third voltage in a third horizontal period.

2. The display device of claim 1, wherein the fourth pixel electrode is electrically connected to the second data line.

3. The display device of claim 1, wherein: when the first gate line receives a copy of the third voltage, the second gate line receives a copy of the second voltage, and the third gate line receives a copy of the first voltage.

4. The display device of claim 1, wherein:
the second voltage is lower than the first voltage.

5. The display device of claim 1, wherein:
a difference between the second voltage and the first voltage is at least 5V and at most than 8V.

6. The display device of claim 1, wherein:
the first voltage is substantially equal to the third voltage.

7. The display device of claim 1, wherein:
polarities of data voltages applied to the first and second data lines are different from each other.

8. The display device of claim 1, wherein:
the first pixel electrode, the third pixel electrode, and the fourth pixel electrode are associated with a first color.

9. The display device of claim 8, wherein:
the second pixel electrode is associated with a second color.

10. A method for driving a display device comprising a plurality of gate lines, a plurality of data lines, and a plurality of pixel electrodes connected to the gate lines and the data lines, the plurality of gate lines including a first gate line, a second gate line, and a third gate line, the plurality of data lines including a first data line and a second data line neighboring the first data line, the method comprising: applying a first copy of a first voltage to the first gate line in a first horizontal period;
applying a first copy of a second voltage to the first gate line in a second horizontal period;
applying a first copy of a third voltage to the first gate line in a third horizontal period; and
applying a copy of a gate-off voltage to the first gate line, wherein
the plurality of pixel electrodes includes a first pixel electrode electrically connected to the first gate line, a second pixel electrode electrically connected to the second gate line, a third pixel electrode electrically connected to the third gate line, and a fourth pixel electrode electrically connected to the second gate line,
the first pixel electrode, the third pixel electrode, and the fourth pixel electrode are disposed between the first data line and the second data line,
the fourth pixel electrode is disposed between the first electrode and the third electrode and neighbors each of the first pixel electrode, the second pixel electrode, and the third pixel electrode, and
the first pixel electrode, the second pixel electrode, and the third pixel electrode are electrically connected to the first data line.

11. The method of claim 10 further comprising applying a second copy of the second voltage to the second gate line when applying the first copy of the third voltage to the first gate line.

12. The method of claim 10 further comprising applying a second copy of the first voltage to the third gate line when applying the first copy of the third voltage to the first gate line.

13. The method of claim 10, wherein:
the second voltage is lower than the first voltage.

14. The method of claim 10, wherein:
a difference between the second voltage and the first voltage is at least 5V and at most 8V.

15. The method of claim 10, wherein:
the first voltage is equal to the third voltage.

16. The method of claim 10, wherein:
polarities of data voltages applied to the first and second data lines are different from each other.

17. The method of claim 10, wherein:
the first pixel electrode, the third pixel electrode, and the fourth pixel electrode are associated with a first color.

18. The method of claim 17, wherein:
the second pixel electrode is associated with a second color.

19. The method of claim 10 further comprising applying a second copy of the first voltage to the second gate line when applying the first copy of the second voltage to the first gate line.

20. The method of claim 10 further comprising applying a second copy of the second voltage to the third gate line when applying a second copy of the third voltage to the second gate line.
